(19) United States
(12) Patent Application Publication
(10) Pub. No.: US 2024/0083338 A1
(43) Pub. Date: Mar. 14, 2024

(54) TIE DOWN DEVICE

(71) Applicant: HID Projects Pty Ltd, Cottesloe (AU)

(72) Inventor: Peter Holliday, Cottesloe (AU)

(73) Assignee: HID Projects Pty Ltd, Cottesloe (AU)

(21) Appl. No.: 18/462,620

(22) Filed: Sep. 7, 2023

(30) Foreign Application Priority Data
Sep. 9, 2022 (AU) 2022902615

(51) Int. Cl. B60P 7/08

(52) U.S. Cl. CPC B60P 7/0823

(57) ABSTRACT

The tie down device 10a has a body 12 with a longitudinal axis 14, a hitching part 16 and a locking part 18. The hitching part 16 includes an internal slot 20 which is formed in the body 12 and a hitch member 22. When the tie down 10a is in use a portion of a tether 24 which has been pushed through the internal slot 20 can be looped about the hitching member 22 to couple or hitch the tether to the body 12. The locking part 18 has a cam surface 26 over which the tether 24 slides when pulled, and a gripping mechanism 28 that grips a portion of the tether 24 downline of the cam surface 26. The internal slot 20, cam surface 26, and the gripping mechanism 28 are all located along the longitudinal axis 14 of the body. The tie down device 10a can be attached at any point along the tether 20.

### CROSS REFERENCE TO RELATED APPLICATION

The present application claims priority to Australian Patent Application No. 2022902615, filed Sep. 9, 2022, which is hereby incorporated herein by reference in entirety.

### TECHNICAL FIELD

The present disclosure relates to a tie down device for use with tethers such as ropes and straps.

### BACKGROUND ART

Tethers such as ropes and straps are widely used for a multitude of purposes such as tying down loads on vehicles and trailers, and securing tents to ground pegs. Often it also becomes necessary to re-tension the tether after it has been tied off or otherwise secured. Mechanical ratchets are sometimes used to secure a tether. Such ratchets can also be used for re-tensioning. Typically, the rachet is permanently fixed to one end of the tether. The other end of the tether is passed over a load, or threaded through an item to be secured, and engaged with the ratchet. The ratchet is then operated to wind in and tighten the tether.

The above references to the background art do not constitute an admission that the art forms a part of the common general knowledge of a person of ordinary skill in the art. The above references are also not intended to limit the application of the disclosed tie down device to any particular form of the tie down device.

### SUMMARY OF THE DISCLOSURE

In one aspect there is disclosed a tie down device comprising;
a body having a longitudinal axis, a hitching part and a locking part;
the hitching part including an internal slot formed in the body and a hitch member about which a portion of a tether inserted through the internal slot can be engaged to couple the tether to the body;
the locking part having a cam surface over which the tether can slide when pulled and a gripping mechanism arranged to grip a portion of the tether downline of the cam surface;
wherein the cam surface and the gripping mechanism are located along the longitudinal axis of the body.

In one embodiment the internal slot and the cam surface are symmetrically formed about a longitudinal axis of the body.

In one embodiment the internal slot has opposite ends of symmetrical shape.

In one embodiment the internal slot and the gripping mechanism are formed symmetrically about the longitudinal axis of the body.

In one embodiment the hitch member extends in a direction perpendicular to the longitudinal axis of the body.

In one embodiment the gripping mechanism comprises a clam cleat.

In one embodiment the clam cleat comprises a valley extending coaxially with the longitudinal axis.

In one embodiment the tie down mechanism comprises a channel formed in the body and configured to receive a tether, the channel being opened at one and extending to the cam surface.

In one embodiment the body is a one-piece structure.

In one embodiment the gripping mechanism comprises a land contiguous with the cam surface and a gripping member biased toward the land, wherein in use, the tether is capable of being located and gripped between the land and the gripping member.

In one embodiment the gripping member includes a plurality of projections configured to bite into the tether.

In one embodiment the gripping member and the land are arranged so that tension on the tether gripped between the land and the gripping member acts to increase bias of the gripping member toward the land.

In one embodiment the internal slot and the gripping mechanism extend perpendicular to the longitudinal axis of the body.

In one embodiment the body includes a hinge coupling between the hitching and the locking part.

In one embodiment the tie down device comprises a channel which is open at one end, the channel spacing the hitch member from the internal slot.

In one embodiment the hitching part comprises a first piece having the hitch member and a second piece having the slot, and wherein the first and second pieces are movably coupled together enabling relative movement of the first and second pieces between a first position where the hitch member is spaced from the second piece, and a second position where the first piece abuts the second piece.

In one embodiment when in the second position, the first and second pieces abut each other at opposite ends of the hitch member.

In one embodiment the tie down device comprises a bias mechanism operable to bias the first and second pieces toward the first position.

In one embodiment the tie down device comprises a channel which is open at one end and extends perpendicular to the longitudinal axis between the first piece and the second piece.

In a second aspect there is disclosed a tie down device comprising;
a body having a hitching part and a locking part;
the hitching part including a neck portion formed with an internal slot and, a hitch member that extends laterally beyond opposite sides of the neck portion whereby the hitching part has a T like shape, and wherein a portion of a tether inserted through the internal slot can be looped behind the hitch member to couple the tether to the hitch member;
the locking part being in the form of a clam cleat configured to grip a portion of the tether to prevent a release of tension in a portion of the tether up-line of the hitching part, while allowing sliding motion of the portion of the tether in the clam cleat in a direction to increase tension in a portion of the tether up-line of the hitching part.

In a third aspect there is disclosed a tie down device comprising;
a body having a hitching part and a locking part;
the hitching part including an internal slot and a hitch member spaced from the internal slot, wherein a portion of a tether inboard of opposite ends of the tether is capable of being inserted through the internal slot to form a loop engageable with the hitch member to couple the tether to the hitch member; and
the locking part being in the form of a cam lock mechanism having surfaces between which an end of the tether can be located and pulled in a direction to increase tension on portion of the tether up-line of the hitching part, the cam lock mechanism biased to bring the surfaces into engagement with the tether to prevent a release of the tension upon cessation of the tether being pulled.

### BRIEF DESCRIPTION OF THE DRAWINGS

Notwithstanding any other forms which may fall within the scope of the tie down device as set forth in the Summary, specific embodiments will now be described, by way of example only, with reference to becoming drawings in which:

FIG. 1 is a front view of a first embodiment of the disclosed tie down device;

FIG. 2 is a perspective view of the embodiment of the tie down device shown in FIG. 1;

FIG. 3 is a bottom view of the tie down device shown in FIG. 1;

FIG. 4 is a side view of the tie down device shown in FIG. 1;

FIGS. 5 to 8 illustrate one sequence of steps for using the embodiment of the tie down device shown in FIGS. 1-4 for securing and tensioning a tether in the form of a rope;

FIG. 9 is a front view of a second embodiment of the disclosed tie down device which is suited for tether is in the form of a strap;

FIG. 10 is a top view of the tie down device shown in FIG. 9;

FIG. 11 is a side view of the tie down device shown in FIG. 9;

FIG. 12 is a perspective view of the tie down device shown in FIG. 9;

FIG. 13 is a rear perspective view of the tie down device shown in FIG. 9;

FIGS. 14 and 15 are representations of a gripping mechanism of the tie down device shown in FIG. 9;

FIGS. 16 to 20 illustrate one sequence of steps for using the embodiment of the tie down device shown in FIGS. 9-15 for securing and tensioning a tether in the form of a strap;

FIGS. 21 and 22 are front view of a third embodiment of the disclosed tie down device showing a hitching portion made of two pieces and where the pieces are in relative first position in FIG. 21 and in a second relative position in FIG. 22; and

FIGS. 23 to 27 illustrate one sequence of steps for using the embodiment of the tie down device shown in FIGS. 21 and 22 for securing and tensioning a tether in the form of a strap.

### DETAILED DESCRIPTION OF SPECIFIC EMBODIMENT

Specific embodiments of the disclosed tie down device will now be described by way of example only. The terminology used herein is for the purpose of describing embodiments only and is not intended to limit the scope of the disclosed tie down device. Unless defined otherwise, all technical and scientific terms used herein have the same meanings as commonly understood by one of ordinary skill in the art to pertaining to tie down device. In the drawings, like reference numbers refer to like parts.

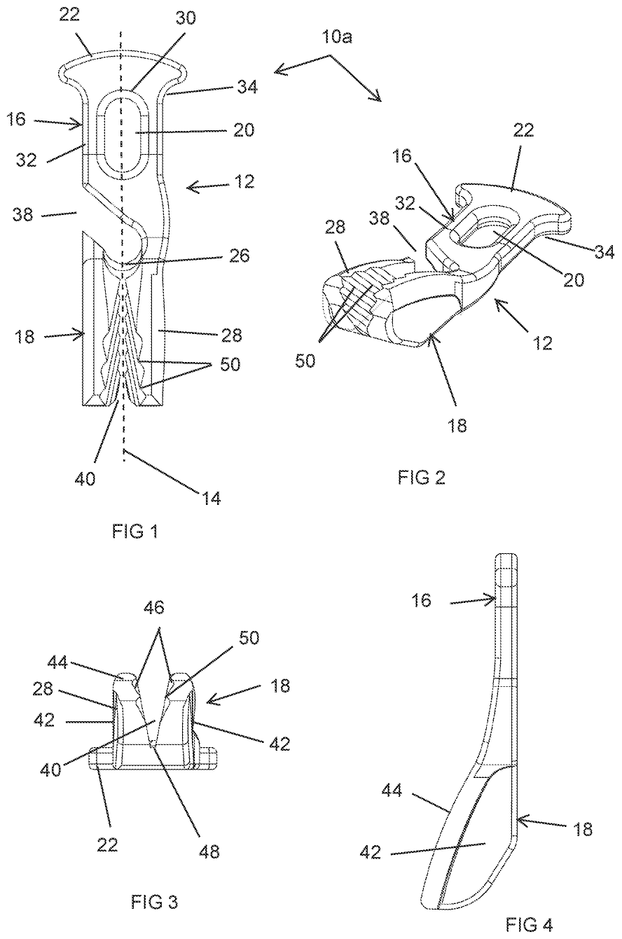

FIGS. 1-4 depict a first embodiment of the disclosed tie down device 10a. The tie down device 10a comprises a body 12. The body 12 has a longitudinal axis 14, a hitching part 16 and a locking part 18.

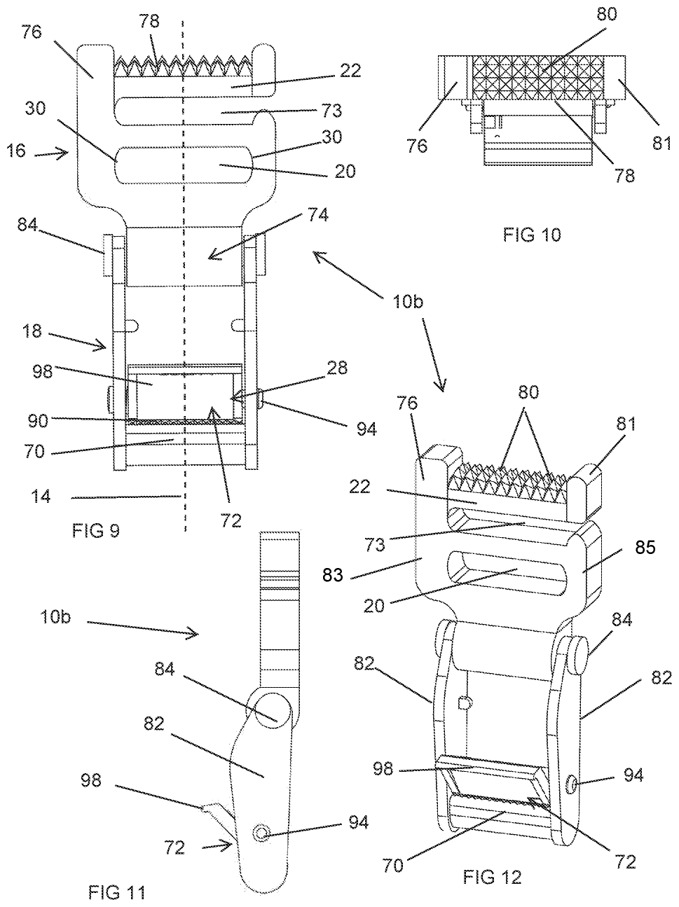

The hitching part 16 includes an internal slot 20 which is formed in the body 12 and a hitch member 22. When the tie down 10a is in use a portion of a tether 24 in the form of a rope (shown in FIGS. 5-12) which has been pushed through the internal slot 20 can be looped about the hitching member 22 to couple or hitch the tether to the body 12.

The locking part 18 has a cam surface 26 over which the tether 24 can slide when pulled, and a gripping mechanism 28 arranged to grip a portion of the tether 24 downline of the cam surface 26. The cam surface 26 and the gripping mechanism 28 are located along the longitudinal axis 14 of the body. As a result of this configuration, it is possible for portions of a tether (a) upline of the body 12, (b) downline of the body 12, (c) returning from a tie down point and passing over the cam surface 26, and (d) extending past or through the gripping mechanism 18, to lie in a straight line that is co-axial with the longitudinal axis 14. Therefore, when pulling on and tensioning the tether 24 the tension can be applied along a straight line containing all the tether portions (a)-(d) mention above. This avoids the imposition of added friction resisting tensioning when one or more portions of the tether 24 are skewed or otherwise not aligned due to the configuration of the tie down.

Looking more closely at the geometry and configuration of the tie down device 10a, it can be seen that the internal slot 20 and the cam surface 26 are symmetrically formed about the longitudinal axis 14. Indeed, the internal slot 20 and the gripping mechanism 28 are formed symmetrically about the longitudinal axis 14. Also, the internal slot 20 has opposite ends 30 of symmetrical shape. In this, but not every, embodiment the symmetry of the opposite ends 30 is about an axis perpendicular to the longitudinal axis 14. Additionally, the hitch member 22 extends in a direction perpendicular to the longitudinal axis 14.

In the tie down device 10a, the hitching part 16 and body 12 include a neck 32 in which the slot 20 is formed. The hitch member 22 extends beyond opposite sides of the neck 32, giving the hitching part a “T” like shape. This creates hook regions 34 on opposite sides of the body 12 between the hitch member 22 and the neck 32 which seat the tether 24.

The tie down device 10a has a channel 36 formed in the body 12 and configured to receive a tether 24. The channel 36 is open at one end 38 and extends to a closed end which is coincident with the cam surface 26. More specifically, the channel 36 runs at an angle to the longitudinal axis 14. The inclination of the channel 36 is such that the open end 38 is closer to the slot 20 than the cam surface 26.

The gripping mechanism 28 is in the form of a clam cleat. The clam cleat comprises a portion of the body 12 formed as a valley 40 that extends coaxially with the common axis 14. The valley 40 is created by and between opposed side walls 42. The side walls 42 have an upper end 44 at which the valley 40 has its greatest width in a direction perpendicular to the longitudinal axis 14. Respective inside surfaces 46 of the side walls 42 taper toward each other in a direction of the depth of the valley 40 leading to a valley floor 48 where the valley 40 has its narrowest width. The inside surfaces 46 are formed with a plurality of spaced apart teeth or ridges 50. The teeth 50 run in an inclined path from the upper end 44 of the side walls 42 to the valley floor 48.

Due to the shape and orientation of the teeth 50 and shape of the channel 40, the clam cleat/gripping mechanism 28, operates with a “one way” action. This allows the tether 24 to be pulled though the gripping mechanism 28 in a direction that increases tension in its up line portion 59 and down line portion 62 without losing grip of the tether and allowing to it slide backwardly to release tension. Indeed, as tension increases, the grip of the clam cleat resisting sliding motion in a backward direction, that would otherwise release the tension, also increases. This is beneficial in allowing a user of the tie down device 10a to re-tension the tether without losing the lock of the clam cleat/gripping mechanism 28.

In this embodiment the body 12 is formed as a one-piece structure. This can be achieved by numerous manufacturing processes including, but not limited to: moulding; an additive manufacturing process such as 3D printing; or machining.

One way of using the tie down device 10a will now be described with reference to FIGS. 5-12.

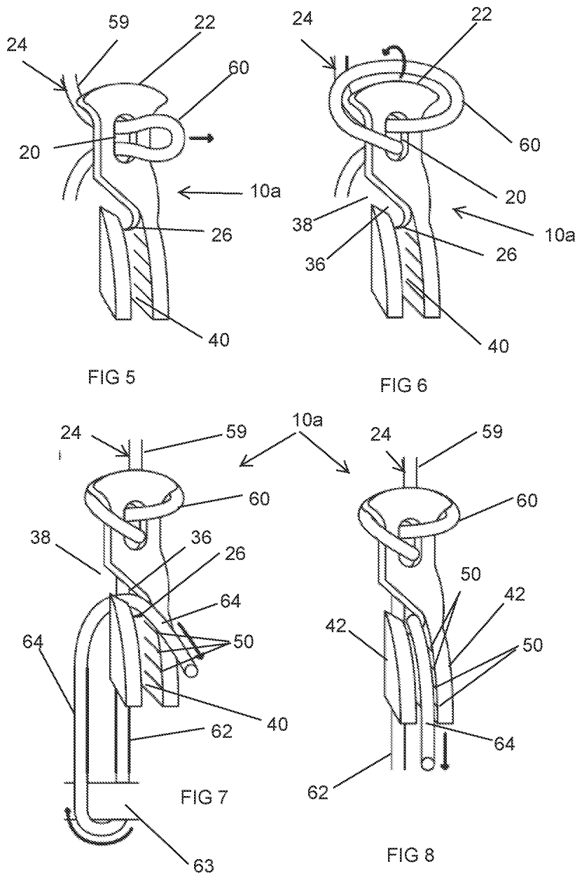

The tether 24 has one end (not shown) up line of a portion 59 that is fixed to an anchor point. FIG. 5 shows a loop 60 formed in the tether 24 and passed through the slot 20. The loop 60 is then engaged with the hitch member 22 as shown progressively in FIGS. 6 and 7, by looping it over and behind the hitch member 22. This effectively hitches or couples the body 12 to the tether 24 so that the loop 60 of the tether 24 is substantially fixed relative to the hitching part 16.

FIG. 7 also show two contiguous portions 62 and 64 of the tether 24 down line from the loop 60. A tie down point 63 (in this example a metal bar fixed to a vehicle) provides a restraint about which the tether 24 is turned and demarks the portions 62 and 64. Next, a user grabs the portion 64 of the tether and passes it through the opening 38 into the channel 36 so that the portion 64 engages the cam surface 26.

The user can now pull down on the portion 64 to tension the tether 24. As this occurs the portion 64 slides across the cam surface 26 in line with the valley 40. When the desired tension has been reached the user pulls the portion 64 as deeply as possible into the valley 40 between the side walls 42 so that the teeth 50 deform, and dig into, the tether 24. The action of the teeth 50 provides friction to retain the portion 64 within the valley 40 without sliding.

To release the tether 24, a user grabs a portion of the tether 64 and lifts it out of the valley 40.

As mentioned above, if it is necessary to re-tension the tether 24, this can be done without losing the lock of the clam cleat/gripping mechanism 28. This is achieved by pulling on portion of the tether 24 extending from the clam cleat 28. This results in the tether portion 64 sliding over the cam surface 26 and along the valley 40.

FIGS. 9-15 show a second embodiment of the tie down device 10b. The same reference numerals used to denote features in the tie down device 10a are used to denote the same features in the tie down device 10b. The tie down device 10a is well suited to a tether in the form of a rope. In contrast, the tie down device 10b is best suited to a tether in the form of a strap.

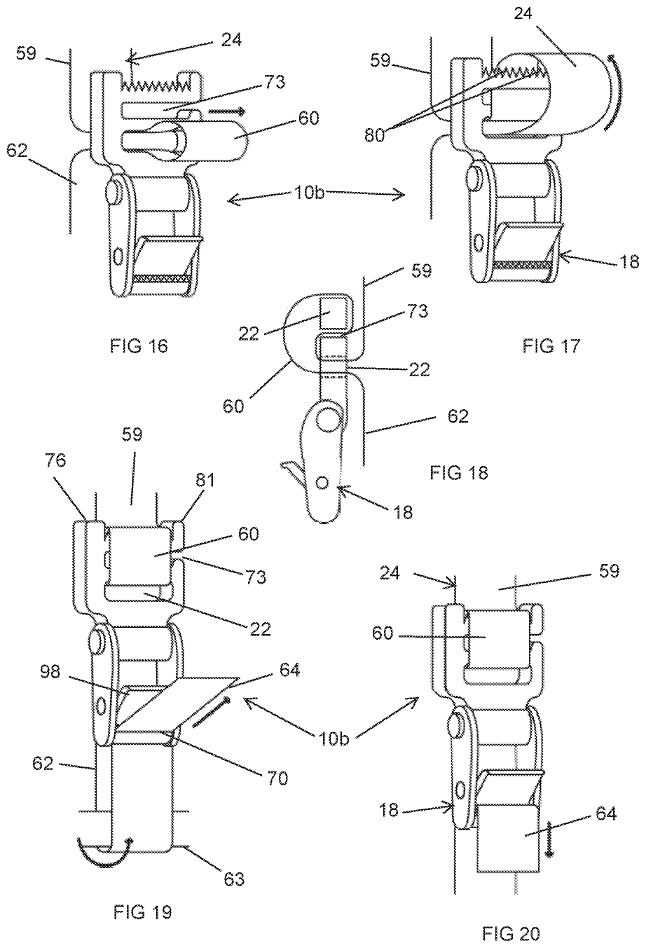

The tie down device 10b has multiple equivalent features to the tie down device 10a. Specifically the tie down device 10b comprises a body 12, with a longitudinal axis 14, a hitching part 16 and a locking part 18. The hitching part 16 includes an internal slot 20 which is formed in the body 12 and a hitch member 22. When the tie down 10b is in use, a portion of a tether 24 (shown in FIGS. 16-20) which has been pushed through the internal slot 20 can be engaged with the hitching member 22 to couple or hitch the tether to the body 12.

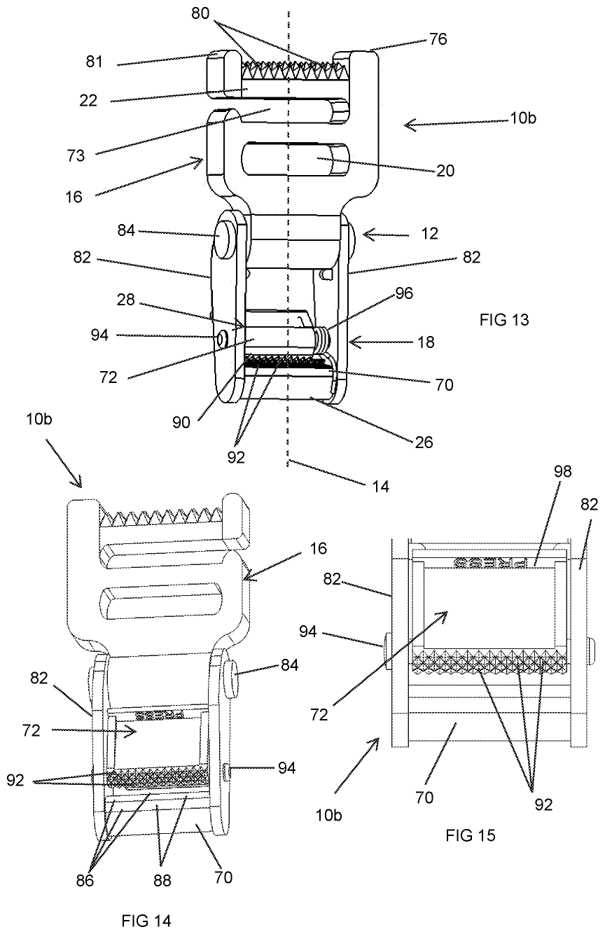

The locking part 18 has a cam surface 26 (most visible in FIG. 13) over which the tether 24 can slide when pulled, and a gripping mechanism 28 arranged to grip a portion of the tether 24 down line of the cam surface 26. The cam surface 26 and the gripping mechanism 28 are located along the longitudinal axis 14 of the body. As a result of this configuration, it is possible for portions of a tether (a) upline of the body 12, (b) downline of the body 12, (c) returning from a tie down point and passing over the cam surface 26, and (d) extending past or through the gripping mechanism, to lie in a straight line that is co-axial with the longitudinal axis 14. Therefore, when pulling on and tensioning the tether 24 the tension can be applied along a straight line containing all of the tether portions (a)-(d) mention above. This avoids the imposition of added friction resisting tensioning when one or more portions of the tether are skewed or otherwise not aligned due to the configuration of the tie down.

As with the device 10a, in the device 10b the:
internal slot 20 and the cam surface 26 are symmetrically formed about the longitudinal axis 14;
internal slot 20 and the gripping mechanism 28 are formed symmetrically about the longitudinal axis 14;
internal slot 20 has opposite ends 30 of symmetrical shape; and
hitch member 22 extends in a direction perpendicular to the longitudinal axis 14.

Some of the differences between the embodiments of the devices 10a and 10b, (hereinafter referred to in general as “devices 10”) are as follows:
a longitudinal axis of the internal slot 20 in the device 10b runs perpendicular to the axis 14 of the body 12, rather than running coaxially as in the device 10a;
the gripping mechanism 28 of the device 10b is in the form of a cam lock mechanism and comprises a land contiguous 70 with the cam surface 26 and a gripping member 72 biased toward the land;
the body 12 includes a hinge coupling 74 between the hitching part 16 and the locking part 18.

Looking more closely at the device 10b, the hitch member 22 extends parallel to the slot 20 and is cantilevered at one end from a post 76 of the body 12. An upper surface 78 of the hitch member 22 is provided with a plurality of teeth 80. The teeth 80 are arranged in a regular matrix pattern of rows and columns. The hitch member 22 also includes a small wall 81 that extends upwardly parallel with the post 76. The post 76 and wall 81 are at opposite ends of, and act to restrain a tether from sliding laterally off, the hitch member 22.

There is also a channel 73 which is open at one end, spacing the hitch member 22 from the portion of the body 12 in which the internal slot 20 is formed. Opposite ends of the slot 20 are closed by body portions 83 and 85, each extending parallel to the longitudinal axis 14. The body portion 83 aligns with and is integrally formed with the post 76. The body portion 85 aligns with the wall 81 and projects into the open end of the slot 73. The projection of the body portion 85 assists in engaging the tether 24 in the channel 73, and, depending on the material from which the device 10 is made and tension applied during use, may also act to limit bending of the cantilevered hitch member 22.

The land 70 and the gripping member 72 extend perpendicular to the longitudinal axis 14 and extend between opposite side plates 82 of the body 12. The side plates 82 are pivotally coupled to the hitching part 16 by a pivot pin 84.

In one embodiment the land 70 may be formed integrally with the side plates 82. Though equally, the land 70 may be formed as a separate piece and later fixed to the side plates 82. As best seen in FIG. 13 the cam surface 26 is provided as a smoothly curved surface on a backside of the land 70. The land 70 has an upper surface provided with a plurality of transversely extending and alternating ridges 86 and grooves 88, shown in FIG. 15.

The gripping member 72 has a surface 90 provided with a plurality of projections 92 (FIGS. 13 and 14) configured to bite into the tether 24. The gripping member 72 is pivotally supported between the side plates 82 on a transversely extending pin 94. A spring 96 biases the gripping member 72 to pivot about the pin 94 toward and/or onto the land 70.

The gripping member 72, land 70 and pin 94 are configured so that tension on a tether that is gripped between the land 70 and the member 72 acts to rotate the member 72 and its surface 90 harder onto the land 72, thereby increasing the grip of the gripping mechanism 28 on the tether 24. A lever 98 is provided as part of the gripping member 72. A user can push on the lever 98 to rotate the surface 90 away from the land 70 to release or loosen a previously gripped tether 24.

One way of using the tie down device 10b will now be described with reference to FIGS. 16-20.

The tether 24, now in the form of a strap, has one end (not shown) up line of a portion 59 that is fixed to an anchor point. FIG. 16 shows loop 60 in the tether 24 passed through the slot 20 in the tie down device 10b. The loop 60 is pulled through the slot a sufficient distance so it can be manipulated upwards so one side slides into the channel 73 while and an opposite side passes over hitch member 22 as shown in FIGS. 17 and 18. The tether 24 is now looped about the hitch member 22. By pulling down on a portion of the tether 62 down line from the loop 60, the loop 60 is tightened about the hitch member 22. This seats a portion of the loop 60 between the post 76 and the wall 81 and causes the teeth 80 on surface 78 to bite into and grip the portion of the loop 60. This effectively hitches or couples the body 12 to the tether 24 so that the loop 60 of the tether 24 is substantially fixed relative to the hitching part 16.

FIGS. 19 and 20 show the tether portion 62 and contiguous portion 64 side by side. A tie down point 63 provides a restraint about which the tether 24 is turned and demarks the portions 62 and 64. The next stage in the use of the tie down device 10b is for a user to grab the portion 64 of the tether with one hand and the locking part 18 of the device 10b with the other hand, pushing on the lever 98 to rotate the surface 90 of gripping mechanism 72 away from the land 70. This creates a gap between the surface 90 and the land 70 thorough which the portion 64 can be threaded. The user threads the portion 64 from a back side of the device 10b into that gap.

While the gap is open the user can now pull down on the portion 64 which will slide over the cam surface 26 to tension the tether 24. When the desired tension has been reached the user released the lever 98 allowing the spring 96 to rotate the gripping member 72 and the surface 90 toward the land 70 to press on the tether. The projections on the surface 90 and the alternating ridges and grooves 86, 88 on the land 70 dig into the tether 24 creating additional friction to retain the portion 64 within the gripping mechanism 28.

To release the tether 24, a user can push on the lever 98 to rotate and lift the surface 90 away from the land 70.

It should be appreciated that in both embodiments, the tie down device 10 can be hitched to a tether 24 by action of the hitching parts 16 at any point along the tether 24 without the need to thread the length of the tether 24 through the tie down device 10 which is a requirement for the tie down devices that include a rachet permanently fixed to one end of the tether as mentioned in the Background.

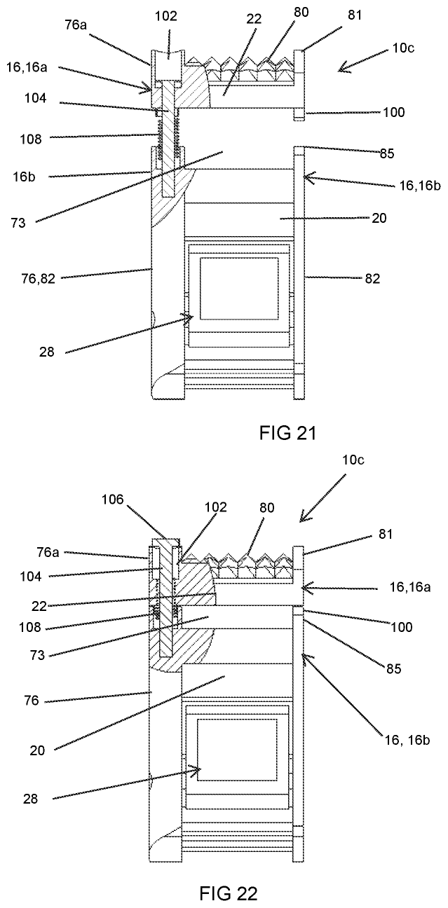

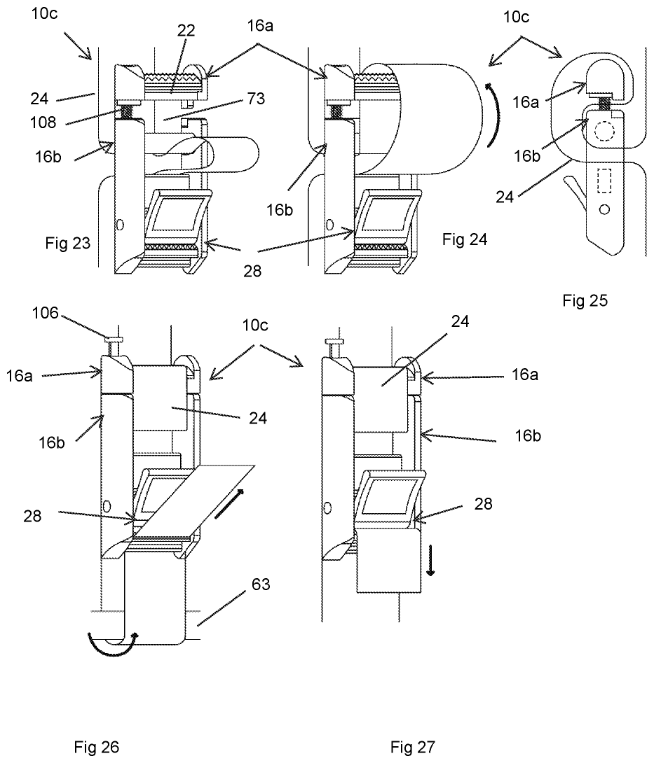

FIGS. 21-27 show a third embodiment of the tie down device 10c. The same reference numerals used to denote features in the tie down device 10b are used to denote the same features in the tie down device 10c. The tie down device 10c, like the tie down devices 10b is best suited to a tether in the form of a strap.

The tie down device 10c differs from the tie down device 10b in several ways. In one difference the hitch member 22 of the tie down device 10c is formed as a movably coupled component of the hitching part 16. That is, in effect the hitching part 16 is formed as two separate pieces, a first piece 16a comprising the hitch member 22, and another piece 16b comprising a portion of the hitching part that includes the slot 20. As explained below the first and second pieces 16a, 16b can be moved relative to each other between a first position shown in FIGS. 21 and 23-25, and a second position shown in FIGS. 22 and 26-27.

When in the first position the hitching member 22/first piece 16b are spaced a maximum distance from the second piece 16b. This coincides with the hitch member 22 being spaced a maximum distance from the slot 20, and height of the channel 73 being at a maximum.

When moved to the second position, the first and second pieces 16a, 16b are brought together. This coincides with the height of the channel 73 being at a minimum.

In this embodiment first piece 16a having the hitch member 22, also includes an upper post portion 76a of the post 76 and the wall 81. A foot 100 descends from an underside of the hitch member 22 in line with the wall portion 81. The post portion 76a is formed with a through hole 102. A pin 104 passes through the hole 102 and is fixed to the post 76 of the body 12. The pin 104 has at its upper and a laterally extending head 106. The head 106 prevents the hitch member 22 from detaching from a remainder of the body 12.

The pin 104 and the hole 102 are configured to prevent the hitch member 22 from rotating or pivoting about the pin 104. In this way the hitch member 22 (and thus the first piece 16a) is restrained from only moving linearly along the pin 104. One simple way of achieving this is to form the pin 104 and the hole 102 with complimentary rectangular cross-sectional shapes.

A biasing device 108, for example a coil spring, is retained on the pin 104 between the post 76 and upper post portion 76a. The biasing device 108 acts to bias the hitch member 22/first piece 16a to move away from the slot 20/second piece 16b to the first position in which the channel 73 has its maximum height. This assists in initially engaging the tether 24 to the device 10c and the looping of the tether 24 about the hitch member 22.

When the device 10c is in use with a tether 24 engaged and being tensioned, the tether 24 pulls on the hitch member 22 causing it to move by sliding along the pin 104 toward the slot 20. This sliding motion will cease when the post portion 76a and the foot 100 abut the post 76 and the body portion 85 respectively. Therefore, the tension in the tether 24 that would otherwise create a bending moment on the post 76 of the device 10b is alleviated in the device 10c and transferred into a pressing force between first and second pieces 16a, 16b. More particularly at the opposite ends of the hitch member 22: (a) the post portion 76a and post 76 are pressed together; and (b) the foot 100 and the wall 85 are pressed together.

In the tie down device 10c the structure of the body 12 is also different that of the device 10b, in that there is no pivot coupling between the hitching part 16 and the locking part 18, and the sidewalls 82 are integrated into the sides of the hitching part 16. This integration is manifested by the sidewalls 82 forming respective continuations with the body portions 83 and 85 at opposite ends of the slot 20. Hence, the side walls 82 are integrated into the second piece 16b of the hitching part 16.

In all other substantive aspects, the device 10c the operation of the device 10c is the same as for the devices 10b. In this regard the device 10c has a gripping mechanism 28 of the same structure and operation as that of device 10b.

FIGS. 23-27 illustrate a method of use of the tie down device 10c. The method of use is used in the same as described above for the device 10b with reference to FIGS. 16-20, and therefore will not be repeated. When used in this manner the first and second pieces 16a, 16b are in their first position as shown in FIGS. 23-25. When tension is applied to the tether 24, the tension causes the first and second pieces 16a, 16b to move the second position where they abut each other as shown in FIGS. 26 and 27. The tension in the tether is transferred to a pressing force between the pieces 16a, 16b. This is to be contracts to a bending moment on the post 76 due to the cantilever coupling of the hitch member 22 in the device 10b.

While several exemplary embodiments have been presented in the foregoing detailed description, it should be appreciated that a vast number of variations exist. It should also be appreciated that the exemplary embodiments of the tie down device are only examples, and are not intended to limit the scope, applicability, or configuration of the present disclosure in any way. Rather, the foregoing detailed description will provide those skilled in the art with a convenient road map for implementing an exemplary embodiment of the disclosed tie down device.

In the claims which follow, and in the preceding description, except where the context requires otherwise due to express language or necessary implication, the word “comprise” and variations such as “comprises” or “comprising” are used in an inclusive sense, i.e., to specify the presence of the stated features but not to preclude the presence or addition of further features in various embodiments of the system and method as disclosed herein.

We claim:

1. A tie down device comprising;
a body having a longitudinal axis, a hitching part and a locking part;
the hitching part including an internal slot formed in the body and a hitch member about which a portion of a tether inserted through the internal slot can be engaged to couple the tether to the body; and
the locking part having a cam surface over which the tether can slide when pulled and a gripping mechanism arranged to grip a portion of the tether downline of the cam surface;
wherein the cam surface and the gripping mechanism are located along the longitudinal axis of the body.

2. The tie down device according to claim 1 wherein the internal slot and the cam surface are symmetrically formed about a longitudinal axis of the body.

3. The tie down device according to claim 1 wherein the internal slot and the gripping mechanism are formed symmetrically about the longitudinal axis of the body.

4. The tie down device according to claim 1 wherein the hitch member extends in a direction perpendicular to the longitudinal axis of the body.

5. The tie down device according to claim 1 wherein the gripping mechanism comprises a clam cleat.

6. The tie down device according to claim 5 wherein the clam cleat comprises a valley extending coaxially with the longitudinal axis.

7. The tie down mechanism according to claim 1 comprising a channel formed in the body and configured to receive a tether, the channel being opened at one and extending to the cam surface.

8. The tie down device according to claim 1 wherein the body is a one-piece structure.

9. The tie down device according to claim 1 wherein the gripping mechanism comprises a land contiguous with the cam surface and a gripping member biased to ward the land, wherein in use, the tether is capable of being located and gripped between the land and the gripping member.

10. The tie down device according to claim 9 wherein the gripping member includes a plurality of projections configured to bite into the tether.

11. The tie down device according to claim 9 wherein the gripping member and the land are arranged so that tension on the tether gripped between the land and the gripping member acts to increase bias of the gripping member toward the land.

12. The tie down device according to claim 9 wherein the internal slot and the gripping mechanism extend perpendicular to the longitudinal axis of the body.

13. The tie down device according to claim 9 wherein the body includes a hinge coupling between the hitching part and the locking part.

14. The tie down device according to claim 1 comprising a channel which is open at one end, the channel spacing the hitch member from the internal slot.

15. The tie down device according to claim 1 wherein the hitching part comprises a first piece having the hitch member and a second piece having the slot, and wherein the first and second pieces are movably coupled together enabling relative movement of the first and second pieces between a first position where the hitch member is spaced from the second piece, and a second position where the first piece abuts the second piece.

16. The tie down device according to claim 15 wherein when in the second position the first and second pieces abut each other at opposite ends of the hitch member.

17. The tie down device according to claim 15 comprising a bias mechanism operable to bias the first and second pieces toward the first position.

18. The tie down device according claim 15 comprising a channel which is open at one end and extends perpendicular to the longitudinal axis between the first piece and the second piece.

19. A tie down device comprising;
a body having a hitching part and a locking part;
the hitching part including a neck portion formed with an internal slot and, a hitch member that extends laterally beyond opposite sides of the neck portion whereby the hitching part has a T like shape, and wherein a portion of a tether inserted through the internal slot can be looped behind the hitch member to couple the tether to the hitch member;
the locking part being in a form of a clam cleat configured to grip a portion of the tether to prevent a release of tension in a portion of the tether up-line of the hitching part, while allowing sliding motion of the portion of the tether in the clam cleat in a direction to increase tension in a portion of the tether up-line of the hitching part.

20. A tie down device comprising;
a body having a hitching part and a locking part;
the hitching part including an internal slot and a hitch member spaced from the internal slot, wherein a portion of a tether inboard of opposite ends of the tether is capable of being inserted through the internal slot to form a loop engageable with the hitch member to couple the tether to the hitch member; and
the locking part being in the form of a cam lock mechanism having surfaces between which an end of the tether can be located and pulled in a direction to increase tension on a portion of the tether up-line of the hitching part, the cam lock mechanism biased to bring the surfaces into engagement with the tether to prevent a release of the tension upon cessation of the tether being pulled.
